(19) United States
(12) Patent Application Publication
(10) Pub. No.: US 2024/0051038 A1
(43) Pub. Date: Feb. 15, 2024

(54) METHOD AND SYSTE FOR HOLDING FAST A WORKPIECE

(71) Applicant: ADEL BATARSEH, RIVERSIDE, CA (US)

(72) Inventor: ADEL BATARSEH, RIVERSIDE, CA (US)

(21) Appl. No.: 17/887,313

(22) Filed: Aug. 12, 2022

(51) Int. Cl. B23B 31/16

(52) U.S. Cl. CPC B23B 31/16083

(57) ABSTRACT

A method and system for holding fast a workpiece using three or more jaws that are mounted on a chuck base. The chuck base includes corresponding jaw guides, which constrain the movement of a respective jaw toward the center of the workpiece. The jaws collectively move toward the center of the workpiece by tightening a gear that engages was each jaw and is included in the chuck base. Each of said jaws includes 1 or 2 two convex contact regions.

### BACKGROUND

When machining a workpiece, it is important to hold the workpiece fast so that it is substantially immovable when forces from a machine tool act thereon. For example, when milling a workpiece, a traditional means of holding the workpiece fast relies upon a series of “T” slots incorporated into a milling table. These “T” slots receive one or more fasteners which in turn act upon the workpiece either directly or through other intermediate mechanical means.

In many cases, the amount of time necessary to fasten the workpiece to a milling table accounts for a large portion of the cost of machining a workpiece. There are many specialized means for fastening a workpiece to a milling table. This is especially true in high-volume applications. A specialized fixture allows rapid fastening of a workpiece and results in a lower overall machining cost.

In many industries, a workpiece is of irregular shape. In some applications, a workpiece is the circular. One such application includes milling of mechanical features on a wheel. In other applications, a workpiece includes portions of a perimeter that are convex. In a sense, a wheel includes one large convex perimeter.

As a face of a circular workpiece is machined, it is often necessary to ensure that the entire face is unobstructed. Otherwise, the workpiece would need to be repositioned in a specialized mounting fixture. A circular workpiece needs to be held fast not only orthogonal to the face which is to be machined, but also must be held fast and all other axes and must be restrained from rotating as a machine tool acts upon the workpiece.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for holding fast a workpiece;

FIG. 2 is a flow diagram that depicts an alternative method wherein imparting a force comprises imparting a set of two forces;

FIG. 3 is a flow diagram that depicts an alternative method wherein imparting a set of two forces provides for resistance of rotational forces imparted to the workpiece as a result of machining the primary worksurface;

FIG. 4 is a flow diagram that depicts an alternative method where force is applied along on orthogonal contact region;

FIG. 5 is a flow diagram that depicts yet another alternative method for applying a force on orthogonal contact region;

FIG. 6 is a flow diagram that depicts an alternative method which provides for vertical restraint of a workpiece;

FIGS. 7 and 8 are pictorial diagrams that illustrate a prior art mounting fixture intended to be used with a substantially circular workpiece;

FIG. 9 is a pictorial diagram that depicts one example embodiment of a system for holding fast a workpiece;

FIG. 10 is a pictorial diagram that illustrates one alternative example 310 embodiment of a jaw that applies two forces in lieu of a single force;

FIG. 11 is a vector diagram that depicts application of two forces to the perimeter of a workpiece;

FIG. 12 is a pictorial diagram that depicts an alternative example embodiment system that includes six jaws, each of which applies a single force to a workpiece;

FIG. 13 is a pictorial diagram that depicts an alternative example embodiment system that includes six jaws, each of which applies two forces to a workpiece;

FIG. 14 is a force vector diagram that depicts the application of two forces from each of six separate jaws; and

FIG. 15 is a sectional view of a system that includes a plunger for providing a downward force upon a workpiece.

### DETAILED DESCRIPTION

In the interest of clarity, several example alternative methods are described in plain language. Such plain language descriptions of the various steps included in a particular method allow for easier comprehension and a more fluid description of a claimed method and its application. Accordingly, specific method steps are identified by the term “step” followed by a numeric reference to a flow diagram presented in the figures, e.g. (step 5). All such method “steps” are intended to be included in an open-ended enumeration of steps included in a particular claimed method. For example, the phrase “according to this example method, the item is processed using A” is to be given the meaning of “the present method includes step A, which is used to process the item”. All variations of such natural language descriptions of method steps are to be afforded this same open-ended enumeration of a step included in a particular claimed method.

Unless specifically taught to the contrary, method steps are interchangeable and specific sequences may be varied according to various alternatives contemplated. Accordingly, the claims are to be construed within such structure. Further, unless specifically taught to the contrary, method steps that include the phrase “ . . . comprises at least one or more of A, B, and/or C . . . ” means that the method step is to include every combination and permutation of the enumerated elements such as “only A”, “only B”, “only C”, “A and B, but not C”, “B and C, but not A”, “A and C, but not B”, and “A and B and C”. This same claim structure is also intended to be open-ended and any such combination of the enumerated elements together with a non-enumerated element, e.g. “A and D, but not B and not C”, is to fall within the scope of the claim. Given the open-ended intent of this claim language, the addition of a second element, including an additional of an enumerated element such as “2 of A”, is to be included in the scope of such claim. This same intended claim structure is also applicable to apparatus and system claims.

In many cases, description of various alternative example methods is augmented with illustrative use cases. Description of how a method is applied in a particular illustrative use case is intended to clarify how a particular method relates to physical implementations thereof. Such illustrative use cases are not intended to limit the scope of the claims appended hereto.

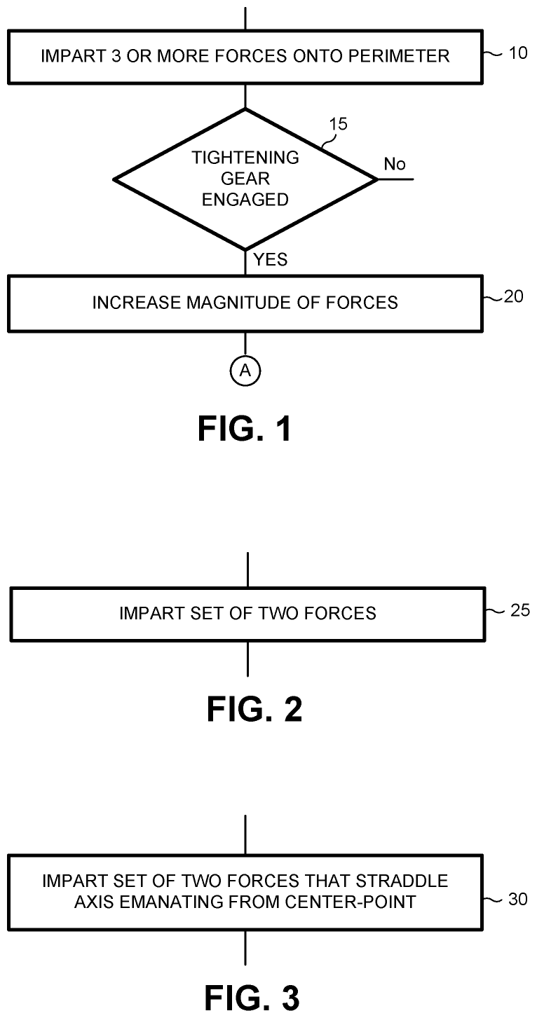

FIG. 1 is a flow diagram that depicts one example method for holding fast a workpiece. According to this example method, three or more forces are imparted upon a perimeter included on said workpiece (step 10). As a tightening gear is engaged (step 15), the magnitude of the forces imparted upon the perimeter of the work piece is increased (step 20). In this example method, the three or more forces are applied substantially coincident with a plane that is substantially parallel with a primary worksurface included in the workpiece.

According to one illustrative use case, forces are imparted onto a perimeter through the use of three or more jaws, which are moved substantially toward the center of a workpiece. It should be appreciated that, according to this illustrative use case, the three or more jaws engage with a tightening gear that comprises a spiral feature that is commonly referred to as a scroll plate. The scroll plate itself rotates through the use of a pinion that engages with a circular rack disposed substantially opposite to the spiral feature included in the scroll plate.

FIG. 2 is a flow diagram that depicts an alternative method wherein imparting a force comprises imparting a set of two forces. It should be appreciated that, when there are significant rotational forces applied to a workpiece as a result of machining a primary worksurface thereon, it is necessary to apply two forces (step 25) which are applied to two portions of the perimeter of the workpiece.

FIG. 3 is a flow diagram that depicts an alternative method wherein imparting a set of two forces provides for resistance of rotational forces imparted to the workpiece as a result of machining a primary worksurface. In this alternative method, an imaginary (i.e. construction) axis emanating from a point that is substantially coincident with the center of a workpiece is used as a basis for straddling the two forces. It should be appreciated that, according to this alternative example method, the two forces are applied substantially in the same direction as the imaginary axis.

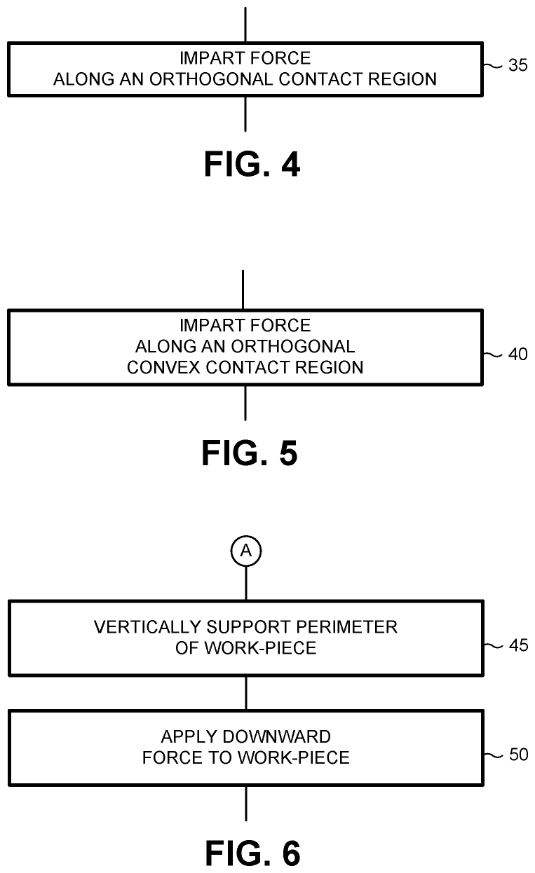

FIG. 4 is a flow diagram that depicts an alternative method where force is applied along an orthogonal contact region. According to this alternative method, a contact region (step 35) is brought in contact with the perimeter of the workpiece, said contact region comprising a region that is substantially orthogonal to the primary worksurface included in the workpiece.

FIG. 5 is a flow diagram that depicts yet another alternative method for applying a force along an orthogonal contact region. In this alternative example method, the force is applied to the perimeter of the workpiece by bringing a convex contact region (step 40) in contact with the perimeter of the workpiece. In this alternative example method, the orthogonal contact region is set substantially orthogonal to the primary worksurface included in the workpiece.

FIG. 6 is a flow diagram that depicts an alternative method which provides for vertical restraint of a workpiece. In this alternative example method, an additional included step is provided for vertically supporting the workpiece proximate to its perimeter (step 45). It should be appreciated that, according to several illustrative use cases, the orthogonal contact region used to restrain the workpiece in an X-Y axes coincident with a primary worksurface included in the workpiece may not provide enough friction to support the workpiece as vertical forces are applied thereto by a machine tool, e.g. an end mill. In some cases, it may be necessary to restrain the workpiece vertically both from the bottom and from the top. Accordingly another alternative example method provides included step for applying a downward force upon the workpiece (step 50).

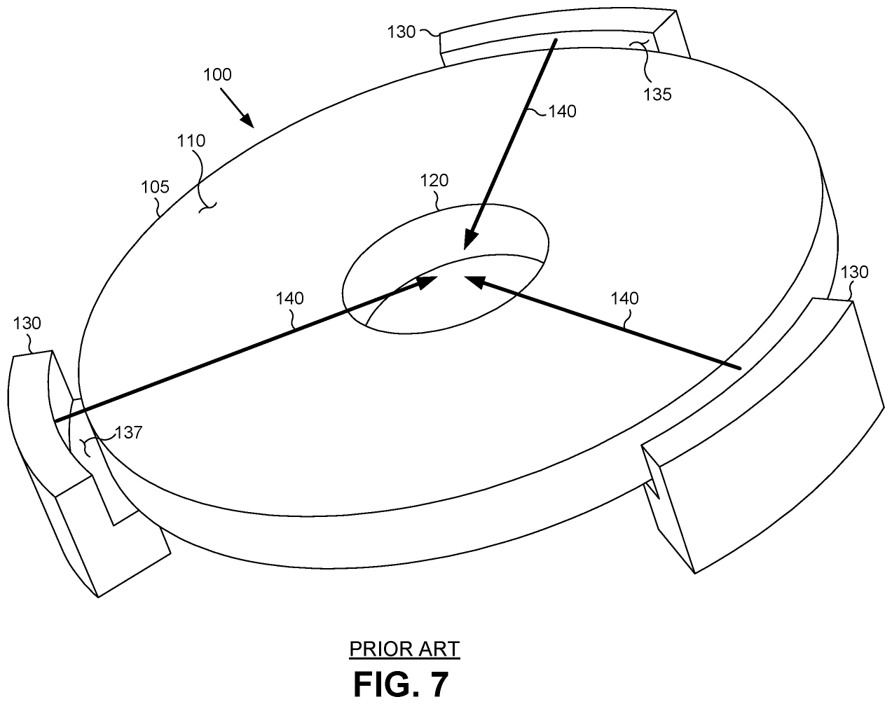

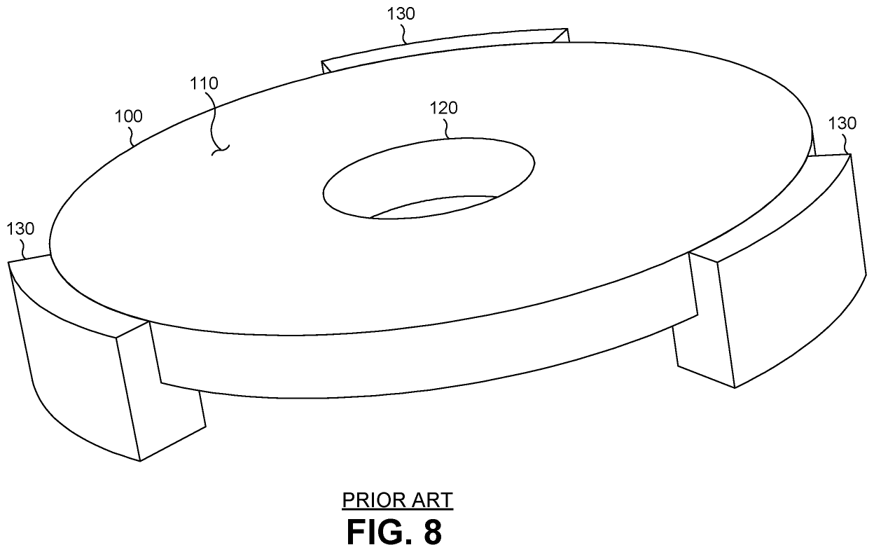

FIGS. 7 and 8 are pictorial diagrams that illustrate a prior art mounting fixture intended to be used with a substantially circular workpiece. In this prior art embodiment, the circular workpiece 100 includes a face 110 which is to be machined by a milling tool. A specialized mounting fixture includes three jaws 130. Each jaw 130 includes a concave surface 135 which must be precision crafted to match the perimeter 105 of the circular workpiece 100. It can be appreciated that the radius of the concave surface 135 must match the radius of the circular workpiece 100 to a high degree of precision. This is necessary to ensure sufficient contact between the concave surface 135 and the outer surface of the circular workpiece 100. Such contact provides the necessary friction to restrain the circular workpiece 100 from rotating during the milling process. And, because it is necessary to ensure sufficient contact between the concave surface 135 and the outer surface of the circular workpiece 100, separate and distinct mounting fixtures are required for each diameter of a circular workpiece 100.

FIG. 7 depicts that as the jaws 130 are moved 140 toward the center of the circular workpiece 100, they will impart force upon the outer perimeter surface of the circular workpiece 100. FIG. 7 also depicts that each jaw 130 includes a shelf 137, which supports vertically the workpiece 100. FIG. 8 shows the prior art mounting fixture in a fully closed position which restrains the workpiece 100 in X and Y axes and also restrains rotation of the circular workpiece 100 during the milling process.

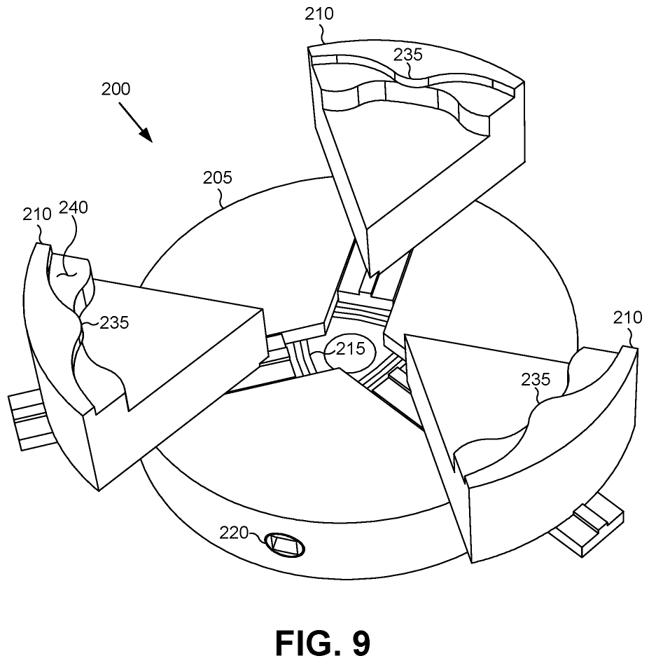

FIG. 9 is a pictorial diagram that depicts one example embodiment of a system for holding fast a workpiece. According to this example embodiment, a system 200 for holding fast a workpiece comprises a chuck base 205, three or more jaws 210, and a tightening gear 215. In this pictorial diagram, only a portion of the tightening gear 215 is visible. The tightening gear 215 is, in this example embodiment, substantially enclosed in the chuck base 205. The tightening gear 215, which comprises a spiral worm gear in this example embodiment, is actuated by way of a key 220 disposed on the outer perimeter of the chuck base 205.

In this example embodiment, each jaw 210 includes a first substantially convex contact region 235. According to one illustrative use case, the use of a single convex contact region is sufficient when there is little rotational force which must be resisted that during a milling process. Also in this embodiment, each jaw 210 includes a shelf 240, which vertically supports a workpiece. In this embodiment, the jaws 210 move toward the center of the chuck base 205 as the tightening gear 215 is engaged by way of the key 220. Because contact is made by way of a convex contact region 235, the system described and claims today support holding fast a workpiece of varying diameters.

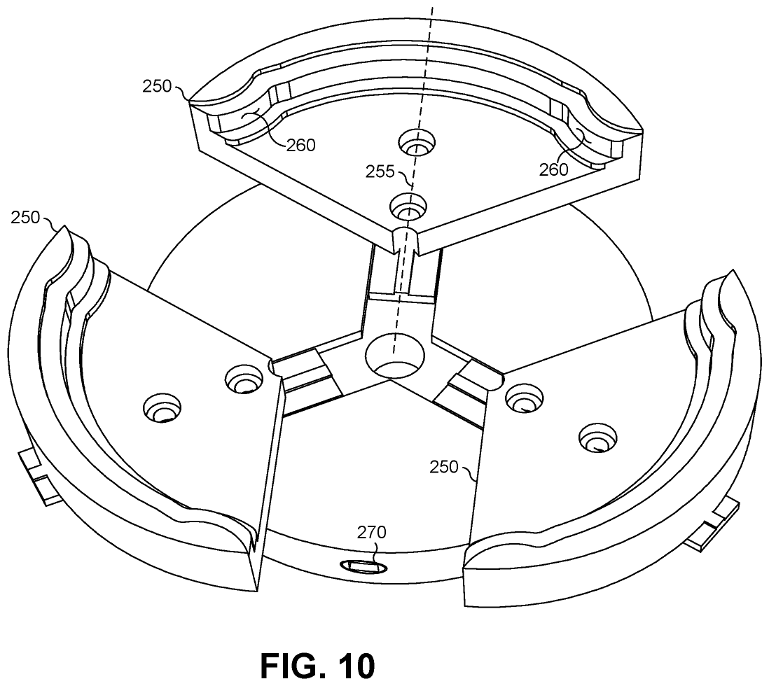

FIG. 10 is a pictorial diagram that illustrates one alternative example 310 embodiment of a jaw that applies two forces in lieu of a single force. In this example alternative embodiment of a jaw 250, the jaw 250 includes two contact regions 260 disposed at either side of the jaw 250. It should be appreciated that, according to this alternative example embodiment, the contact regions are substantially orthogonal to the primary worksurface included in a workpiece which is held fast by the system. Also, in this alternative example embodiment, the contact regions 260 are substantially equal distance from the centerline of the jaw. As in other configurations of the system, the chuck base includes a tightening gear that is engaged by a key 270 included therein.

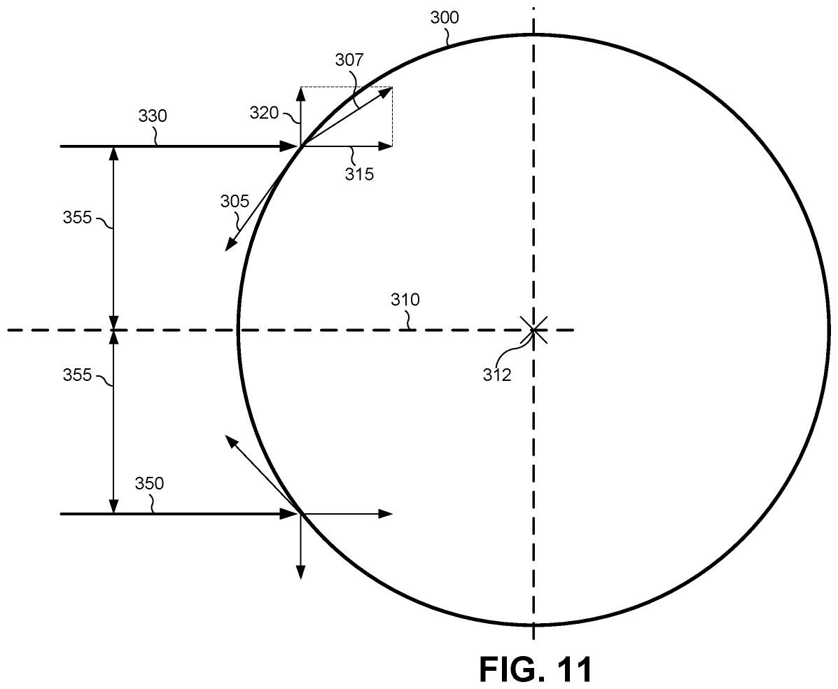

FIG. 11 is a vector diagram that depicts application of two forces to the perimeter of a workpiece. It should be appreciated that, in those embodiments where two forces are applied to the perimeter 300 of a workpiece, the forces are disposed to straddle a construction centerline 310 which emanates from a point 312 substantially coincident with the center of the workpiece. In a typical embodiment, the two forces (330, 350) are applied in a direction substantially parallel with the centerline 310 and are set at a substantially equal distance 355 from said centerline 310.

Application of two forces is typically necessary in those applications where there is significant rotational force 305 exhibited by the workpiece as a result of machining a primary surface included there on. By offsetting a force 330, the force presented to the perimeter 300 includes a first force 315 that is substantially oriented coincident with the applied force 330. However, a second force 320 is also imparted upon the perimeter 300, which yields a resultant force 307 that resists the rotational force 305.

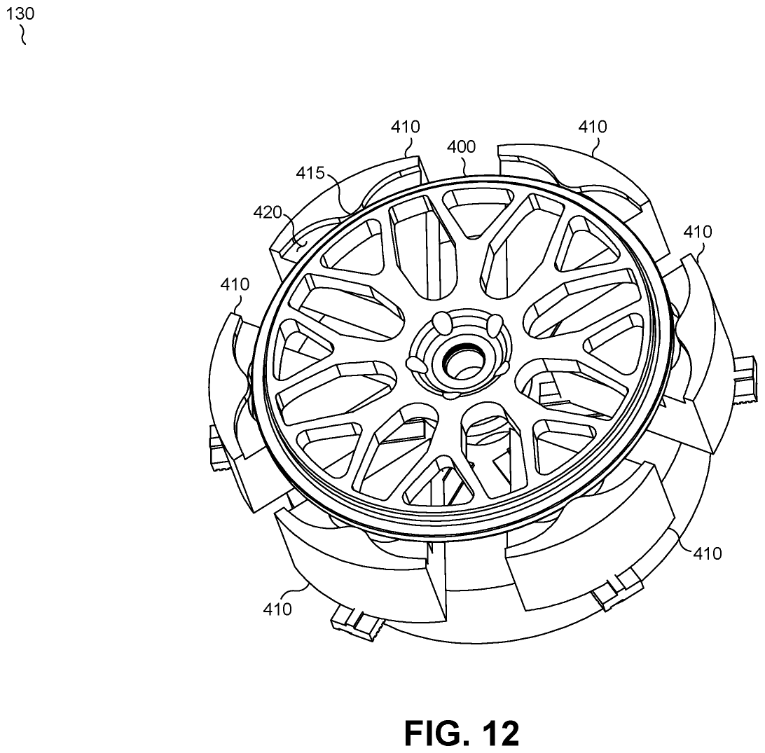

FIG. 12 is a pictorial diagram that depicts an alternative example embodiment system that includes six jaws, each of which applies a single force to a workpiece. It should be appreciated that, according to various alternative example embodiments of a system for holding fast a workpiece, a workpiece (e.g. a wheel 400) is held fast by three or more jaws. This figure depicts an embodiment that includes six jaws 410. In this example alternative embodiment, each jaw includes a shelf 420 and a single convex contact region 415.

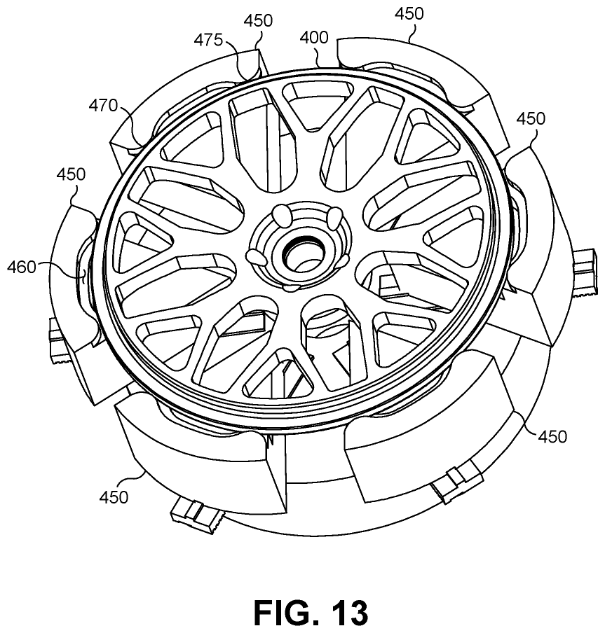

FIG. 13 is a pictorial diagram that depicts an alternative example embodiment of system that includes six jaws, each of which applies two forces to a workpiece. The system for holding fast a workpiece 400 that includes six jaws 450 wherein each of said the jaws 450 includes a first substantially convex contact region 470 and a second substantially convex contact region 475 is useful in those applications wherein the workpiece 400 (e.g. a wheel as depicted in the figure) experiences greater rotational forces than could be overcome by using six jaws wherein each of the six jaws includes only a single substantially convex contact region as shown in FIG. 12. Such alternative example embodiment of a system includes jaws 450 that further include a shelf 464 for providing vertical support to the workpiece 400.

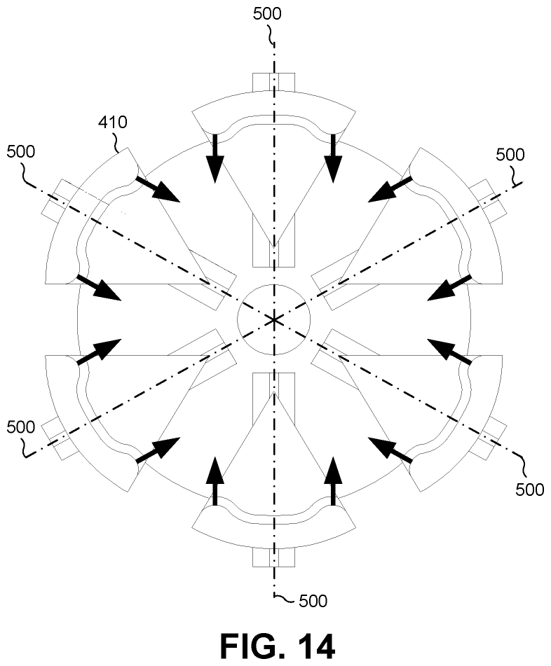

FIG. 14 is a force vector diagram that depicts the application of two forces from each of six separate jaws. Just as depicted in FIG. 11, each jaw 410 applies two forces when the two substantially convex contact regions included in the jaw make contact with the outer perimeter of the workpiece. Analogous to the depiction of forces in FIG. 11, these forces are applied in a manner substantially parallel to, but offset from an imaginary construction axis 500. Each of said jaws 410 has associated therewith one such imaginary construction axis 500, which begins at a point substantially at the center of the workpiece and extends outward through a mid-plane of its associated jaw 410. It should likewise be appreciated that, as depicted in this figure, the imaginary axis 500 coincides with the direction of travel of its associated jaw 410.

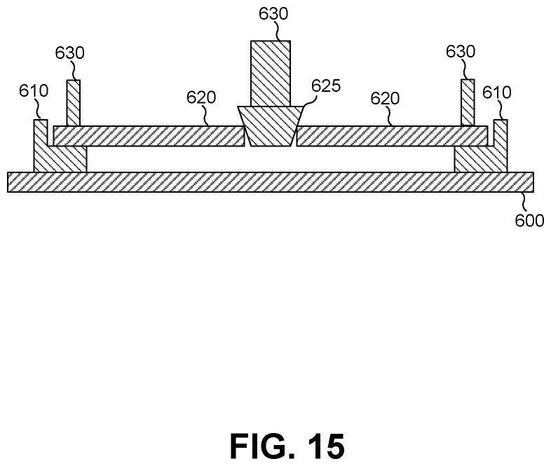

FIG. 15 is a sectional view of a system that includes a plunger for providing a downward force upon a workpiece. As already described, a system of a first embodiment includes three or more jaws 610, which are mechanically coupled to a chuck base 610. As also already described, each jaw 610 of several alternative embodiments includes a shelf, which provides an upward force upon a workpiece 620. According to this alternative example embodiment of a system, the system further includes a plunger 630, which provides a downward force upon the workpiece 620.

According to one illustrative use case, the plunger 630 acts upon a circular void included in the workpiece 620, said void being located at a point substantially coincident with the center of the workpiece 620. According to yet another alternative embodiment, the plunger 630 includes a conical nosecone 625 that imparts the downward force along an inner perimeter of a void included in the workpiece 620. According to another alternative embodiment, a plurality of plungers 630 is disposed proximate to the outer perimeter of the workpiece 620.

It should likewise be appreciated that, in alternative example embodiments of a system for holding fast a workpiece described herein, comprise a chuck base that utilizes a spiral scroll plate and a circular rack and pinion system for causing the scroll plate to rotate about a point that is substantially coincident with the center of the chuck base. Such technology is well understood in the art and is commonly found in chuck assemblies used to hold a workpiece in a lathe. It should be appreciated that the workpiece in a lathe is spinning and machining is applied to the perimeter of such spinning workpiece, which is in contrast to machining a front surface that is substantially parallel to a plane in which the jaws traversed toward the center of the chuck base.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents. Such equivalents include apparatus and systems that have varying numbers of jaws were in each jaw applies either a single force or two forces upon the perimeter of the workpiece.

Variations that include four jaws, five jaws, six jaws, seven jaws, and beyond are to be included in the scope of the claims appended hereto and in all such variations in the number of jaws comprises at least one or more of one orthogonal convex contact region and/or two orthogonal convex contact regions.

What is claimed is:

1. A method for holding fast a work-piece having a perimeter that includes a curved portion:
imparting upon the perimeter a minimum of three forces substantially coincident with a plane that is substantially parallel with a primary work surface included in the work-piece; and
increasing the magnitude of said forces in a substantially equal manner when a tightening gear is engaged.

2. The method of claim 1 wherein imparting a force upon the perimeter comprises imparting a set of two forces.

3. The method of claim 1 wherein imparting a force upon the perimeter comprises imparting a set of two forces each substantially straddling a construction line emanating outward from a center-point of the work-piece.

4. The method of claim 1 wherein imparting a force upon the perimeter comprises imparting a force along a contact region that is substantially orthogonal to the primary work surface included in the work-piece.

5. The method of claim 1 wherein imparting a force upon the perimeter comprises imparting a force along a substantially convex contact region that is substantially orthogonal to the primary work surface included in the work-piece.

6. The method of claim 1 further comprising:
vertically supporting the perimeter of the work-piece.

7. The method of claim 1 further comprising: a
applying a downward force to the work-piece to substantially preclude vertical movement of the work-piece relative to the three or more forces imparted to the perimeter of said work-piece.

8. A system for machining a work-piece comprising:
chuck base that includes three or more jaw guides;
three or more jaws each disposed in a corresponding jaw guide, wherein each jaw includes a first substantially convex contact region; and
chuck tightening gear that, when engaged, causes each jaw to move toward a center point along an axis substantially parallel with a primary work surface included in the work-piece.

9. The system of claim 8 wherein the contact region is substantially linear.

10. The system of claim 8 wherein the contact region comprises a substantially linear convex feature.

11. The system of claim 8 wherein the contact region is substantially linear and is oriented substantially orthogonal to a primary work surface included in the work-piece.

12. The system of claim 8 wherein the contact region comprises a substantially linear convex feature and is oriented substantially orthogonal to a primary work surface included in the work-piece.

13. The system of claim 8 wherein each jaw includes a shelf for supporting a workpiece from the bottom.

14. The system of claim 8 further comprising a plunger for applying a downward force upon the workpiece.

15. The system of claim 8 wherein each jaw includes a second substantially convex contact region and where the first and second substantially convex contact regions straddle an axis that is substantially parallel with a primary work surface included in the work-piece and is substantially directed toward the center point.

16. The system of claim 15 wherein the first and second contact regions and are oriented substantially orthogonal to a primary work surface included in the work-piece.

17. A wheel that includes a perimeter and is manufactured according to a process that includes:
imparting upon the perimeter a minimum of three forces substantially coincident with a plane that is substantially parallel with a primary work surface included in the wheel; and
increasing the magnitude of said forces in a substantially equal manner when a tightening gear is engaged.

18. The wheel of claim 17 wherein imparting a force upon the perimeter comprises imparting a set of two forces.

19. The wheel of claim 17 wherein imparting a force upon the perimeter comprises imparting a set of two forces each substantially straddling a construction line emanating outward from a center-point of the work-piece.

20. The wheel of claim 17 wherein imparting a force upon the perimeter comprises imparting a force along a contact region that is substantially orthogonal to the primary work surface included in the work-piece.

21. The wheel of claim 17 which is manufactured according to a process that further includes:
vertically supporting the perimeter of the wheel.

22. The wheel of claim 17 which is manufactured according to a process that further includes:
applying a downward force to the wheel to substantially preclude vertical movement of the wheel relative to the three or more forces imparted to the perimeter of said wheel.
